(19) United States
(12) Patent Application Publication
(10) Pub. No.: US 2012/0111567 A1
(43) Pub. Date: May 10, 2012

(54) FORMATE SALTS FOR INCREASED STABILITY OF POLYACRYLAMIDE FLUIDS

(76) Inventors: Lijun Lin, Sugar Land, TX (US); Alhad Phatak, Houston, TX (US); Leiming Li, Sugar Land, TX (US); Carlos Abad, Richmond, TX (US)

(21) Appl. No.: 12/942,120

(22) Filed: Nov. 9, 2010

(51) Int. Cl. E21B 43/16; C09K 8/00

(52) U.S. Cl. 166/305.1; 507/224

(57) ABSTRACT

Methods and apparatus for using a fluid within a subterranean formation, including forming a fluid comprising an acrylamide copolymer and a formate salt, and introducing the fluid to the subterranean formation, wherein a temperature of the formation is about 149° C. or warmer. Also, methods and apparatus for a fluid for use within a subterranean formation, including an acrylamide copolymer comprising polyacrylamide, a formate salt comprising potassium, and a crosslinker comprising zirconium. Additionally, methods and apparatus for using a fluid within in a subterranean formation, including forming a fluid comprising an acrylamide copolymer and a formate salt, and introducing proppant into the fluid to form a mixture, introducing the mixture to the subterranean formation, wherein a temperature of the formation is about 149° C. or warmer.

### FIELD

The invention relates to fluid additives for use in oilfield applications for subterranean formations. More particularly, the invention relates to stabilizing a fluid comprising a polymer at high temperature.

### BACKGROUND

The statements in this section merely provide background information related to the present disclosure and may not constitute prior art.

This invention relates to fluids used in treating a subterranean formation. In particular, the invention relates to the use of polymers at high temperature. Various types of fluids are used in operations related to the development and completion of wells that penetrate subterranean formations, and to the production of gaseous and liquid hydrocarbons from natural reservoirs into such wells. These operations include perforating subterranean formations, fracturing subterranean formations, modifying the permeability of subterranean formations, or controlling the production of sand or water from subterranean formations. The fluids employed in these oilfield operations are known as drilling fluids, completion fluids, work-over fluids, packer fluids, fracturing fluids, stimulation fluids, conformance or permeability control fluids, consolidation fluids, and the like. Stimulation operations are generally performed in portions of the wells which have been lined with casings, and typically the purpose of such stimulation is to increase production rates or capacity of hydrocarbons from the formation.

A need remains for an inexpensive and reliable well treatment fluid and for methods of use during well treatments such as well completion, stimulation, and fluids production. Especially as reservoirs at high temperature are pursued for hydrocarbon recovery, effective, relatively stable polymer-based fluids are desirable. That is, a stable fluid system is needed to reach temperatures as high as 450 deg F. (232 deg C.).

### SUMMARY

Embodiments of the invention provide methods and apparatus for using a fluid within a subterranean formation, including forming a fluid comprising an acrylamide copolymer and a formate salt; and introducing the fluid to the subterranean formation, wherein a temperature of the formation is about 149° C. or warmer. Also, embodiments of the invention provide methods and apparatus for a fluid for use within a subterranean formation, including an acrylamide copolymer comprising polyacrylamide, a formate salt comprising potassium, and a crosslinker comprising zirconium. Additionally, embodiments of the invention provide methods and apparatus for using a fluid within in a subterranean formation, including forming a fluid comprising an acrylamide copolymer and a formate salt, and introducing proppant into the fluid to form a mixture, introducing the mixture to the subterranean formation, wherein a temperature of the formation is about 149° C. or warmer.

### BRIEF DESCRIPTION OF THE DRAWINGS

FIG. 1 is a plot of viscosity at 450 deg F. (232 deg C.) as a function of time for fluids containing poly(acrylamide-acrylate), zirconium x-linker, clay stabilizer, sodium thiosulfate, and with no or 0.12 weight percent potassium formate.

FIG. 2 is a plot of viscosity at 450 deg F. (232 deg C.) as a function of time for fluids containing poly(acrylamide-acrylate), zirconium x-linker, clay stabilizer, sodium thiosulfate, and with no or 0.12 weight percent potassium formate.

### DETAILED DESCRIPTION

The procedural techniques for pumping fluids down a wellbore to fracture a subterranean formation are well known. The person that designs such treatments is the person of ordinary skill to whom this disclosure is directed. That person has available many useful tools to help design and implement the treatments, including computer programs for simulation of treatments.

In the summary of the invention and this description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific numbers, it is to be understood that inventors appreciate and understand that any and all data points within the range are to be considered to have been specified, and that inventors have disclosed and enabled the entire range and all points within the range. All percents, parts, and ratios herein are by weight unless specifically noted otherwise.

The term “polyacrylamide” includes any suitable polyacrylamide material, such as, but not limited to, polyacrylamide homopolymers, chemical modifications of polyacrylamide such as partially hydrolysed polyacrylamide (PHPA), copolymers of acrylamide such as copolymers of acrylamide and acrylic acid, neutralized copolymers of acrylamide and acrylic acid, copolymers of acrylamide and sodium acrylate, (despite its different source, all these copolymers are also commonly known in the industry as partially hydrolyzed polyacrylamide, PHPA), copolymers of acrylamide and AMPS, cationic polyacrylamides, etc. The term “copolymers”, refers and also includes all possible and different compositions and monomer distributions (such as random or block copolymer), or tapered copolymer.

Embodiments of this invention relate to using formate salts to increase stability of cross-linked polyacrylamide fluids at high temperatures such as 300 deg F. (149 deg C.) or even 450 deg F. (232 deg C.). A conventional temperature stabilizer, sodium thiosulfate, may function acceptably at temperatures up to about 425 deg F. (218 deg C.), especially if auxiliary chemicals are introduced to the fluid. But at 450 deg F. (232 deg C.), the thiosulfate is not sufficient to maintain a stable fluid.

Thus, a fluid comprising polyacrylamide and formate salt for high temperature stability is useful. The addition of potassium formate increases fluid viscosity of cross-linked polyacrylamide fluids at high temperatures such as 149 deg C. or warmer, 162 deg C. or warmer, 176 deg C. or warmer, 204 deg C. or warmer, 218 deg C. or warmer, and 232 deg C. or warmer. Other formate salts will have similar stabilizing effect. Using formate salt for stability may also benefit fluids comprising other copolymers of acrylamide including acrylamidomethylpropane sulfonate (AMPS) and vinylpyrrolidone. Potential applications of such fluid systems can be extended from fracturing to other treatments such as sand control and water control.

The fluid may optionally also comprise a clay stabilizer, a metal crosslinker, and/or other components. The composition may further include other additives such as dispersing aids, surfactants, pH adjusting compounds, buffers, antioxidants, colorants, biocides, which do not materially change or interfere with the desirable characteristics of the well treatment fluid. The composition can include any additive that is to be introduced into the well treatment fluid separately, provided that it is essentially inert in the concentrate. In one embodiment, at least one other well treatment fluid additive is present, such as proppants, fibers, crosslinkers, breakers, breaker aids, friction reducers, surfactants, clay stabilizers, buffers, and the like. Also, the activity of an additive(s) can be delayed, in one embodiment, and the delay can at least in part be facilitated where the additive is preferentially concentrated or otherwise reactively separated from the polymer.

Some fluid compositions useful in some embodiments of the invention may also include a gas component, produced from any suitable gas that forms an energized fluid or foam when introduced into an aqueous medium. See, for example, U.S. Pat. No. 3,937,283 (Blauer, et al.) incorporated herein by reference. Preferably, the gas component comprises a gas selected from the group consisting of nitrogen, air, argon, carbon dioxide, and any mixtures thereof. More preferably, the gas component comprises nitrogen or carbon dioxide, in any quality readily available. The gas component may assist in the fracturing and acidizing operation, as well as the well clean-up process.

The fluid in one embodiment may contain from about 10 percent to about 90 percent volume gas component based upon total fluid volume percent, preferably from about 20 percent to about 80 percent volume gas component based upon total fluid volume percent, and more preferably from about 30 percent to about 70 percent volume gas component based upon total fluid volume percent. In one embodiment, the fluid is a high-quality foam comprising 90 volume percent or greater gas phase.

In some embodiments, the fluids used may further include a crosslinker. Adding crosslinkers to the fluid may further augment the viscosity of the fluid. Crosslinking consists of the attachment of two polymeric chains through the chemical association of such chains to a common element or chemical group. Suitable crosslinkers may comprise a chemical compound containing a polyvalent ion such as, but not necessarily limited to, boron or a metal such as chromium, iron, aluminum, titanium, antimony and zirconium, or mixtures of polyvalent ions. The crosslinker can be delayed, in one embodiment, and the delay can at least in part be facilitated where the crosslinker or activator is concentrated or otherwise reactively separated in the partitioning agent-rich phase.

Breakers may optionally be used in some embodiments of the invention. The purpose of this component is to “break” or diminish the viscosity of the fluid so that this fluid is even more easily recovered from the formation during cleanup. With regard to breaking down viscosity, oxidizers, enzymes, or acids may be used. Breakers reduce the polymer's molecular weight by the action of an acid, an oxidizer, an enzyme, or some combination of these on the polymer itself.

Preferred breakers include 0.1 to 20 pounds per thousand gallons of conventional oxidizers such as ammonium persulfates, live or encapsulated, or sodium bromated, potassium periodate, calcium peroxide, chlorites, and the like. In oil producing formations the film may be at least partially broken when contacted with formation fluids (oil), which may help de-stabilize the film. The breaker can be delayed, in one embodiment, and the delay can at least in part be facilitated where the breaker or breaker activator is concentrated or otherwise reactively separated in the partitioning agent-rich phase.

A fiber component may be included in the fluids used in the invention to achieve a variety of properties including improving particle suspension, and particle transport capabilities, and gas phase stability. Fibers used may be hydrophilic or hydrophobic in nature, but hydrophilic fibers are preferred. Fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON™ polyethylene terephthalate (PET) Fibers available from Invista Corp. of Wichita, Kans., USA, 67220. Other examples of useful fibers include, but are not limited to, polylactic acid polyester fibers, polyglycolic acid polyester fibers, polyvinyl alcohol fibers, and the like. When used in fluids of the invention, the fiber component may be included at concentrations from about 1 to about 15 grams per liter of the liquid phase of the fluid, preferably the concentration of fibers are from about 2 to about 12 grams per liter of liquid, and more preferably from about 2 to about 10 grams per liter of liquid.

Embodiments of the invention may use other additives and chemicals that are known to be commonly used in oilfield applications by those skilled in the art. These include, but are not necessarily limited to, materials in addition to those mentioned hereinabove, such as breaker aids, oxygen scavengers, alcohols, scale inhibitors, corrosion inhibitors, fluid-loss additives, bactericides, iron control agents, organic solvents, and the like. Also, they may include a co-surfactant to optimize viscosity or to minimize the formation of stabilized emulsions that contain components of crude oil, or as described hereinabove, a polysaccharide or chemically modified polysaccharide, natural polymers and derivatives of natural polymers, such as cellulose, derivatized cellulose, guar gum, derivatized guar gum, or biopolymers such as xanthan, diutan, and scleroglucan, synthetic polymers such as polyacrylamides and polyacrylamide copolymers, oxidizers such as persulfates, peroxides, bromates, chlorates, chlorites, periodates, and the like. Some examples of organic solvents include ethylene glycol monobutyl ether, isopropyl alcohol, methanol, glycerol, ethylene glycol, mineral oil, mineral oil without substantial aromatic content, and the like.

Embodiments of the invention may also include placing proppant particles that are substantially insoluble in the fluids. Proppant particles carried by the treatment fluid remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it will typically be from about 20 to about 100 U.S. Standard Mesh in size. Naturally occurring materials may be underived and/or unprocessed naturally occurring materials, as well as materials based on naturally occurring materials that have been processed and/or derived. Suitable examples of naturally occurring particulate materials for use as proppants include, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particalization, processing, etc. Further information on nuts and composition thereof may be found in Encyclopedia of Chemical Technology, Edited by Raymond E. Kirk and Donald F. Othmer, Third Edition, John Wiley & Sons, Volume 16, pages 248-273 (entitled “Nuts”), Copyright 1981, which is incorporated herein by reference.

The concentration of proppant in the fluid can be any concentration known in the art, and will preferably be in the range of from about 0.05 to about 3 kilograms of proppant added per liter of liquid phase. Also, any of the proppant particles can further be coated with a resin to potentially improve the strength, clustering ability, and flow back properties of the proppant.

Conventional propped hydraulic fracturing techniques, with appropriate adjustments if necessary, as will be apparent to those skilled in the art, are used in some methods of the invention. One fracture stimulation treatment according to the present invention typically begins with a conventional pad stage to generate the fracture, followed by a sequence of stages in which a viscous carrier fluid transports proppant into the fracture as the fracture is propagated. Typically, in this sequence of stages the amount of propping agent is increased, normally stepwise. The pad and carrier fluid can be a fluid of adequate viscosity. The pad and carrier fluids may contain various additives. Non-limiting examples are fluid loss additives, crosslinking agents, clay control agents, breakers, iron control agents, and the like, provided that the additives do not affect the stability or action of the fluid.

Embodiments of the invention may use other additives and chemicals that are known to be commonly used in oilfield applications by those skilled in the art. These include, but are not necessarily limited to, materials in addition to those mentioned hereinabove, such as breaker aids, oxygen scavengers, alcohols, scale inhibitors, corrosion inhibitors, fluid-loss additives, bactericides, iron control agents, organic solvents, and the like. Also, they may include a co-surfactant to optimize viscosity or to minimize the formation of stabilized emulsions that contain components of crude oil, or as described hereinabove, a polysaccharide or chemically modified polysaccharide, natural polymers and derivatives of natural polymers, such as cellulose, derivatized cellulose, guar gum, derivatized guar gum, or biopolymers such as xanthan, diutan, and scleroglucan, synthetic polymers such as polyacrylamides and polyacrylamide copolymers, oxidizers such as persulfates, peroxides, bromates, chlorates, chlorites, periodates, and the like. Some examples of organic solvents include ethylene glycol monobutyl ether, isopropyl alcohol, methanol, glycerol, ethylene glycol, mineral oil, mineral oil without substantial aromatic content, and the like.

### EXAMPLES

The following examples are presented to illustrate the preparation and properties of fluid systems, and should not be construed to limit the scope of the invention, unless otherwise expressly indicated in the appended claims. All percentages, concentrations, ratios, parts, etc. are by weight unless otherwise noted or apparent from the context of their use.

One example is given below to illustrate the effect of potassium formate on cross-linked polyacrylamide fluids. The base fluid contained 0.72 weight percent active poly(acrylamide-acrylate), 1.5 volume percent zirconium cross-linker solution, 0.2 volume percent clay stabilizer solution (50 percent tetramethylammonium chloride), and 0.36 weight sodium thiosulfate. The polymer was added to the mix water in the form an emulsion product and was allowed to fully hydrate before the cross-linker was added. The resulting gel viscosities were measured on a Grace M5600 rheometer at a shear rate of 100/s with ramps down to 75, 50, and 25/s then back up to 50, 75, and 100/s every 20 min. The typical heating time to reach the test temperature was in the range of 15 to 20 min.

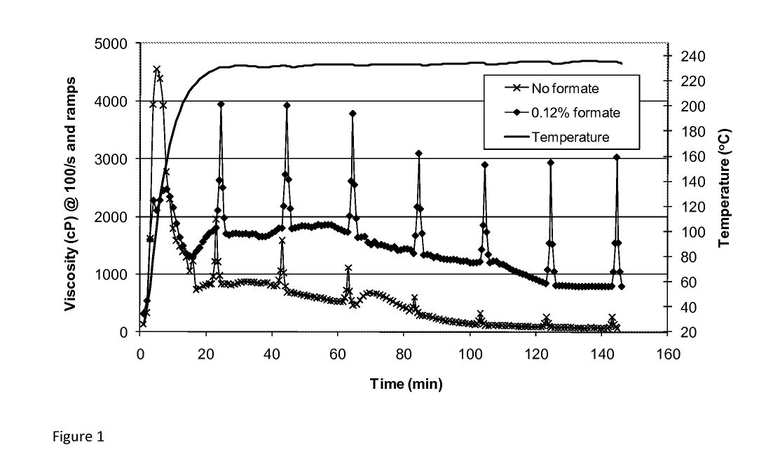

FIG. 1 plots viscosity at 450 deg F. (232 deg C.) as a function of time for fluids containing 0.72 weight percent poly(acrylamide-acrylate), 1.5 volume percent zirconium x-linker solution, 0.2 volume percent clay stabilizer solution, 0.36 weight percent sodium thiosulfate, and with no or 0.12 weight percent potassium formate. FIG. 1 illustrates the effect of potassium formate at 450 deg F. (232 deg C.). The base fluid has no more than 100 cP (at 100/s) at time of 100 min. Sodium thiosuflate alone as a temperature stabilizer was not capable of maintaining a stable fluid for 2 hr. With 0.12 weight percent potassium formate added, the fluid stability was significantly improved with viscosity greater than 800 cP (at 100/s) for the duration of the test. Potassium formate apparently acted as a temperature stabilizer. Other formate salts likely will have similar stabilizing effect. These salts can include ammonium formate, lithium formate, sodium formate, potassium formate, rubidium formate, cesium formate, and francium formate.

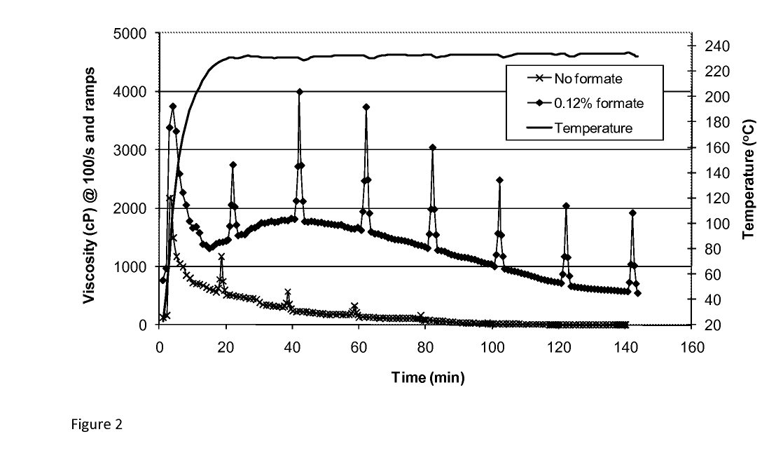

FIG. 2 illustrates another example. FIG. 2 plots viscosity at 450 deg F. (232 deg C.) as a function of time for fluids containing 0.60 weight percent poly(acrylamide-acrylate), 1.0 volume percent zirconium x-linker solution, 0.2 volume percent clay stabilizer solution, 0.36 weight percent sodium thiosulfate, and with no or 0.12 weight percent potassium formate.

The fluid contained reduced amounts of polymer and cross-linker as compared with the system in FIG. 1. Again, in the presence of potassium formate, the fluid was stable for a minimum of two hours at 450 deg F. (232 deg C.).

The particular embodiments disclosed above are illustrative only, as the invention may be modified and practiced in different but equivalent manners apparent to those skilled in the art having the benefit of the teachings herein. Furthermore, no limitations are intended to the details herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method of using a fluid within in a subterranean formation, comprising:
forming a fluid comprising an acrylamide copolymer and a formate salt; and
introducing the fluid to the subterranean formation,
wherein a temperature of the formation is about 149° C. or warmer.

2. The method of claim 1, wherein the copolymer is polyacrylamide, partially hydrolysed polyacrylamide (PHPA), copolymers of acrylamide and acrylic acid, neutralized copolymers of acrylamide and acrylic acid, copolymers of acrylamide and sodium acrylate, partially hydrolyzed polyacrylamide, copolymers of acrylamide and AMPS, cationic polyacrylamides, vinylpyrrolidone, or a combination thereof.

3. The method of claim 1, wherein the formate salt is potassium formate.

4. The method of claim 1, wherein the formate salt is sodium formate and potassium formate.

5. The method of claim 1, wherein the acrylamide copolymer is crosslinked.

6. The method of claim 5, wherein the fluid further comprises a crosslinker.

7. The method of claim 6, wherein the crosslinker comprises metal.

8. The method of claim 7, wherein the crosslinker comprises zirconium.

9. The method of claim 1, wherein the temperature is about 204° C. or warmer.

10. The method of claim 1, wherein the temperature is about 232° C. or warmer.

11. The method of claim 1, wherein the copolymer is polyacrylamide, the formate salt is potassium formate and the temperature is about 232° C. or warmer.

12. A fluid for use within a subterranean formation, comprising:
an acrylamide copolymer comprising polyacrylamide;
a formate salt comprising potassium; and
a crosslinker comprising zirconium.

13. The fluid of claim 12, wherein the copolymer is crosslinked.

14. The fluid of claim 12, wherein the formate salt is potassium formate.

15. The fluid of claim 12, wherein the formate salt is potassium formate and sodium formate.

16. The fluid of claim 15, further comprising clay stabilizer.

17. A method of using a fluid within in a subterranean formation, comprising:
forming a fluid comprising an acrylamide copolymer and a formate salt; and
introducing proppant into the fluid to form a mixture;
introducing the mixture to the subterranean formation;
wherein a temperature of the formation is about 149° C. or warmer.

18. The method of claim 17, wherein the copolymer is polyacrylamide, partially hydrolysed polyacrylamide (PHPA), copolymers of acrylamide and acrylic acid, neutralized copolymers of acrylamide and acrylic acid, copolymers of acrylamide and sodium acrylate, partially hydrolyzed polyacrylamide, copolymers of acrylamide and AMPS, cationic polyacrylamides, vinylpyrrolidone, or a combination thereof.

19. The method of claim 17, wherein the formate salt is potassium formate.

20. The method of claim 19, wherein the fluid further comprises a zirconium crosslinker.

21. The method of claim 20, wherein the temperature is about 232° C. or warmer.
